(19) United States
(12) Patent Application Publication
(10) Pub. No.: US 2006/0008568 A1
(43) Pub. Date: Jan. 12, 2006

(54) Low carbohydrate bread product

(76) Inventors: Ali A. Elmusa, Leawood, KS (US); Charles A. Morris, Overland Park, KS (US)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(21) Appl. No.: 11/179,841

(22) Filed: Jul. 12, 2005

Related U.S. Application Data
(60) Provisional application No. 60/587,221, filed on Jul. 12, 2004.

(51) Int. Cl. A21D 10/00

(52) U.S. Cl. 426/549

(57) ABSTRACT

A low carbohydrate bread product is prepared by using a bread dough substantially free of wheat flour. A wheat starch, a wheat protein isolate, and a soluble fiber are mixed into a bread dough and baked to provide a bread product with increased protein and fiber content and reduced carbohydrate content.

### CROSS REFERENCE TO RELATED APPLICATIONS

This application claims the benefit of U.S. provisional patent application Ser. No. 60/587,221 filed Jul. 12, 2004, which is incorporated in its entirety by reference. This application relates to U.S. patent application Ser. No. to be determined entitled “Low Carbohydrate Four Additive,” which claims the benefit of U.S. provisional patent application Ser. No. 60/586,001 filed Jul. 7, 2004, and this application relates to U.S. patent application Ser. No. to be determined entitled “Dehydrated Edible Beans in Bread” filed Jul. 1, 2005, which claims the benefit of U.S. provisional application No. 60/585,394, all of which are incorporated in their entirety by reference herein.

### FIELD OF THE INVENTION

Bread products, bread doughs, ingredients used for making bread products, and methods of making bread products are provided herein.

### BACKGROUND OF THE INVENTION

The method of making bread is well known in the art and has been practiced for thousands of years. A bread dough is mixed together and heated for an amount of time sufficient to bake the dough, also allowing the dough to leaven by a chemical reaction that releases a gas and expands the bread to a sponge-like structure. A typical bread dough includes flour, sugar, water, shortening agents, salt, conditioners, and leavening agents.

Flour is a powdery substance derived from the grinding and sifting of a grain, typically a wheat grain, and it provides the structural matrix of a bread dough as well as the matrix for the baked bread product resulting therefrom. A component of flour, gluten, is a mixture of many proteins and serves as flour's primary agent for providing the structural integrity to the dough and resultant bread product. Gluten and gluten-forming proteins, such as gliadin and glutenin, provide elasticity, cohesiveness and binding properties to the bread dough. The elasticity of the gluten further allows expansion of the dough upon leavening. Bread products, in particular, tortillas, crackers, and other flat breads, often require sheeting, rolling, or flattening prior to cutting or die cutting of the dough. The gluten in flour in particular, with its binding and elastic properties, is essential to the proper formation of these flat breads.

The production of flour from grain is also well known in the art. Flour is typically milled by roller processes in which seeds are alternatively put through a series of high speed steel rollers and a mesh sifter. The rollers crack the grain, allowing the endosperm (the largest part of the seed) to be separated from the bran and germ. The endosperm is then ground to the desired consistency. For whole grain flours, the bran and germ are returned to the flour at the end of the process. In total, this is simply a mechanical process consisting of cracking, separating, and thereafter grinding the desired portion to the appropriate consistency.

Grains, the flour derived therefrom, and the resulting bread product are rich in carbohydrates. Carbohydrates are formed of a polymeric chain of saccharides, or sugar molecules. Carbohydrates are a vital source of energy for the human body as their breakdown in the body provides a source of saccharides, particularly glucose, which is the primary source of cellular energy. Glucose is in turn absorbed into the blood and transported to the body tissues for use or storage in the liver and muscles as glycogen, which is comprised of long strings of glucose.

Despite the importance of carbohydrates as an energy source, recent diet trends have led to an increased consumer demand for foods that are compatible with a diet which is low in carbohydrate content. Bread products and other grain-based products with a high carbohydrate content have accordingly seen reduced consumer demand in the marketplace. Bread products with wheat flour substitutes (particularly soy flour) often have adverse taste characteristics associated therewith. There is a need, therefore, for bread products with reduced carbohydrate content, desirable taste characteristics, and increased protein and fiber content in comparison to bread products made from wheat flour.

For a number of reasons, including the reduction of carbohydrate content of a bread product, flour substitutes not derived from grain or wheat have been developed. Flour substitutes derived from non-wheat sources are more difficult to produce and are typically required to undergo additional processes beyond the simple separation and grinding necessary for wheat grain. Soy flour, for example, is derived from soy beans and is made by roasting the soy beans and subsequently grinding the roasted soy beans into a fine powder.

In some instances, bread made using soy flour can result in undesirable characteristics. While soy flour provides increased protein of bread products in relation to a wheat-based flour, it can sometimes have an undesirable taste that adversely affects the bread products. Bread products with soy flour can also be more dense than a bread product derived from a wheat-based flour and, accordingly, have a texture that is sometimes inferior to bread made from a wheat-based flour. Furthermore, doughs which are high in soy content sometimes do not bind well, are sticky, and are not pliable. Bread doughs made from soy powder often do not machine properly since the dough often adheres to rollers and wires of dough sheeter heads and such dough can be difficult to press out to a uniform thickness. These disadvantages have accordingly limited the use of soy flour within bread doughs.

U.S. Pat. No. 6,479,089 to Cohen (“Cohen '089”) attempts to solve the problems associated with soy flour by incorporating a pre-gelatinized starch within a dough in addition to a soy component. The pre-gelatinized starches disclosed as preferable are rice starch, arrowroot starch, pea starch, tapioca starch, or potato starch. The soy component is present in the doughs of Cohen '089 in amounts ranging from 60% to 90% by weight (wt.) of the dry ingredients, and the pre-gelatinized starch comprises from 10% to 40% by wt. of the dry ingredients, to which water and other liquid ingredients are added. While Cohen '089 may improve the quality of a bread dough based on a soy flour, it does so by adding a pre-gelatinized starch component, thus adding processing steps and still including many of the negative aspects associated with products made from soy bean flour.

U.S. Pat. No. 5,789,012 to Slimak (“Slimak '012”) discloses various substitutes for wheat flour, i.e., flours prepared from a variety of different tubers, including white sweet potatoes, cassaya, edible aroids, tropical yams, Lotus, arrowroot, buckbean, and amaranth. The disclosure of Slimak '012 is directed to a new process for preparing the flour from tubers, the process including the steps of: (1) peeling and washing the tubers, (2) shredding the washed tubers, (3) dehydrating the shredded tubers, and then (4) comminuting the tubers to a fine power. This process may be repeated with an additional step of partially or completely cooking the comminuted powder. Presoaking and/or any step involving hydration of the tubers is undesirable, as a product with a low moisture content is preferred. Furthermore, the size of the flour particle encompasses a large range, with no apparent criticality to a preferred size; e.g., the range includes particles which may pass through a screen with openings of 0.025 mm (25 microns) to particles which may pass through a screen with openings of 0.6 mm (600 microns). Most examples describe a particle of 0.38 mm (380 microns) being used.

The disclosure of Slimak '012 is directed to a flour substitute for people who are allergic to wheat flour, but does not provide a bread product with palatability and texture properties suitable for mass consumer appeal. Soy flour as a substitute for wheat flour, therefore, can fall short in many categories, such as flavor and texture. There is a need to provide an ingredient which provides increased fiber and protein content in bread while also providing the bread with a desirable taste.

It is also known to use replacements not containing a soy or legume-based flour for wheat flour in dietetic bread products. U.S. Pat. No. 6,322,826 to Zohoungbogbo discloses a food used to substitute for cereal flours and foods which may be prepared therefrom. The food disclosed therein includes at least 50% protein, up to 15% carbohydrates, and from 35% to 50% plant fibers. The protein component is selected from the group consisting of gluten, soya proteins, milk proteins, in particular from soya milk without lactose, animal proteins obtained from meat or dried or smoked fish, egg albumen and yolk, wheat proteins, wheat germ, rice germ, soya bean protein, or pea protein. The plant fiber may be chosen from cereal fibers, in particular, wheat, maize, and oats, and soya bean brands, vegetable fibers, in particular, tomato, spinach, inulin, and acacia and fruit fibers, in particular, oranges and apples. The “flours” of Zohoungbogbo, however, do not include an isolated wheat starch and do not contain a soluble fiber, for example.

It is also known to separate a wheat flour into individual ingredients; for example, gluten, starches, pentosans, lipids, fiber, vitamins, and minerals, each capable of being used individually in various industrial applications. Gluten in particular may be added to flour of poor quality to improve the baking properties of the flour, while starches isolated from wheat flour have applications varying from a stiffening component for laundry, to an abrasive for sandpaper, to a food ingredient. Various methods are used to isolate the ingredients from wheat flour. U.S. Pat. No. 6,451,553 to Olsen, for example, provides for the separation of the gluten content from a flour by mixing the flour with a liquid and subsequently separating the dough into a fraction comprising gluten and at least one other fraction, and separating the gluten from the other fraction by the addition of an oxidoreductase enzyme.

### SUMMARY OF THE INVENTION

Provided therefore are compositions of dough and bread products derived therefrom substantially free of wheat flour. Also provided are methods of making such dough and bread products. The dough and bread products described herein may comprise one or more useful properties, such as reduced carbohydrate content, increased protein content, increased fiber content, and the like. The methods include mixing wheat starch with a wheat protein isolate and a soluble fiber to form a dry mixture. Water can then be added to the dry mixture to form a dough and the dough baked to form a bread product. In one embodiment, the bread product is a tortilla. Soluble fiber may comprise indigestible dextrin, such as Fibersol-2® (Matsutani America, Decatur, Ill.). The protein isolate can be wheat gluten.

In one embodiment, the wheat starch may comprise from 30% to 50% by wt. of the dry mixture, the wheat protein isolate may comprise from 10% to 25% by wt. of the dry mixture, and the soluble fiber may comprise from 4% to 10% by wt. of the dry mixture.

Also provided herein is a bread dough comprising a dry mixture and water. The dry mixture includes a wheat starch, a wheat protein isolate and a soluble fiber. In one embodiment, the soluble fiber can be an indigestible dextrin-containing composition, such as Fibersol-2® (Matsutani America, Decatur, Ill.). The wheat protein isolate can be wheat gluten. In one embodiment, the wheat starch comprises from 30% to 50% by wt. of the dry mixture, the wheat protein isolate comprises from 10% to 25% by wt. of the dry mixture, and the soluble fiber comprises from 4% to 10% by wt. of the dry mixture.

Also provided herein is a bread product high in protein and fiber content and low in carbohydrate content. The bread product is made from the method of mixing wheat starch with wheat protein isolate and soluble fiber to form a dry mixture, adding water to the dry mixture, and baking the resulting bread dough to form the bread product. In some embodiments, the bread product is a tortilla.

It has been surprisingly found that bread products produced by the methods described herein have reduced carbohydrate content, increased protein and fiber content, while also having palatability, texture, and appearance characteristics suitable for mass consumption. Also, it has been surprisingly found that introducing isolated flour components separately in a bread dough substantially devoid of wheat flour, that the desired characteristics may be provided. It has been surprisingly found that the methods described herein provide more controlled dough properties and baking environment than when simply using wheat flour. The compositions of the invention and methods of the invention provide a bread product with more easily manipulated characteristics, such as increased protein and fiber, and reduced carbohydrate content. It has further been surprisingly found that the introduction of soluble fiber, such as one comprising indigestible dextrin, facilitates in the creation of such a controlled environment. It has been further found that the reduction of contaminants found in protein isolates and starch isolate, for example, pentosans, lipids, fiber, vitamins and minerals, yields a more efficient food source and a more nutritious bread product as a result thereof.

It should be understood that this invention is not limited to the embodiments disclosed in this summary, but it is intended to cover modifications that are within the spirit and scope of the invention, as defined in the claims.

### DETAILED DESCRIPTION OF INVENTION

It is to be understood that certain descriptions of the present invention have been simplified to illustrate only those elements and limitations that are relevant to a clear understanding of the present invention, while eliminating, for purposes of clarity, other elements. Those of ordinary skill in the art, upon considering the present description of the invention, will recognize that other elements and/or limitations may be desirable in order to implement the present invention. However, because such other elements and/or limitations may be readily ascertained by one of ordinary skill upon considering the present description of the invention, and are not necessary for a complete understanding of the present invention, a discussion of such elements and limitations is not provided herein. As such, it is to be understood that the description set forth herein is merely exemplary to the present invention and is not intended to limit the scope of the claims.

Furthermore, certain compositions within the present invention can be described in the form of ingredients that may be used to produce certain doughs and bread products derived therefrom. It will be understood, however, that the present invention may be embodied in forms and applied to end uses that are not specifically and expressly described herein. For example, one skilled in the art will appreciate that embodiments of the present invention may be incorporated into any food.

Other than in the examples herein, or unless otherwise expressly specified, all of the numerical ranges, amounts, values and percentages, such as those for amounts of materials, elemental contents, ingredients, times and temperatures of reaction, ratios of amounts, and others, in the specification and claims may be read as if prefaced by the word “about” even though the term “about” may not expressly appear with the value, amount, or range. Accordingly, unless indicated to the contrary, the numerical parameters set forth herein are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total mass weight. When Baker's percentage is used herein, the values are relative to the flour content, i.e., flour comprises 100% of the composition and all the other ingredients are calculated in proportion to the weight of flour; thus, the percentage of the ingredient equals (the weight of ingredient divided by weight of total flour) multiplied by 100. Those of skill in the art recognize that percent mass weight, actual mass weight, and Baker's percentage are all inter-convertible.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. The articles “a,” “an,” and “the” are used herein to refer to one or more than one (i.e., to at least one) of the grammatical object of the article. By way of example, “an element” means one or more elements, and thus, possibly, more than one element is contemplated and may be employed or used.

Provided herein is a dough, a bread product made therefrom, and a method of making a bread product. The dough and bread product are useful for increasing protein and fiber content and reducing carbohydrate content of bread products. The dough of the present invention may be used to prepare a bread product such as a tortilla. It is also contemplated to make other bread products, including bagels, bread, crackers, pitas, muffins, biscuits, pizza shells, pizza crusts, bread, buns, doughnuts, muffins, rolls, cookies, brownies, pancakes, pastas, cereals, sheeted snacks, frozen doughs, and various other baked and processed foods. As used herein, “bread dough” means a dough useful in preparation of bread products. Such products can be prepared by adding gluten and leavening the product with either yeast or a chemical leavener, such as baking soda or baking powder.

The methods provided herein contemplate the preparation of a bread product without the addition of wheat flour. In some embodiments, the bread product has reduced carbohydrate content and increased protein and fiber content. The methods provided herein contemplate mixing wheat starch with a wheat protein isolate and soluble fiber to form a dry mixture. Water can then be added to the dry mixture. In some embodiments, the bread dough resulting therefrom can be baked to form a bread product. A proofing step for leavening the dough may be included. The tortilla may be baked in a temperature range of 218° C. to 260° C., for example, at 252° C. The tortilla may be baked for a time range of thirty seconds to two minutes, for example, from forty-five to sixty seconds.

Other ingredients may be added to the bread dough of the invention, including, but not limited to, chemical leavening additives, shortening additives, salt, insoluble fiber (e.g., cellulose, such as an alpha cellulose), additional flavoring additives, and the like.

The term “wheat protein isolate” as used herein refers to protein compositions, such as gluten, manufactured by separating the protein from wheat flour. This can be accomplished by a physical extraction from a protein and water mixture, as the protein is typically insoluble in water. The water-insoluble protein fraction, such as gluten compositions, can be dried to form a tan, free-flowing powder. Wheat gluten is comprised of two major protein fractions, glutenin and gliadin. Glutenin has a high molecular weight (greater than 100,000 MW), is highly elastic and is substantially insoluble in alcohol. Gliadin has a lower molecular weight (less than 100,000 MW), is very extensible, and is even less soluble in alcohol than gluten. Different gradations of gluten may be used in the methods provided herein, the different gradations being differentiable primarily by protein percentage present in the gluten.

As used herein, the term “wheat starch” refers to a chemically and a thermally unmodified composition comprised of straight chain amylose and branched chain amylopectin isolated from a wheat flour, such as the starch derived from the largest particles of the bimodal wheat system, with granule size in the range of about 20-40 microns diameter, preferably about 25-35 microns. Wheat starch may be produced from wheat by various methods, all of which include crushing the plant material, washing the starch free from the protein, cellulose and other substances, further concentrating the starch composition, and subsequently drying and grinding the composition. Isolated wheat starch has been found to be useful in preparing the compositions of the invention and practicing the methods of the invention because it lacks the impurities of flour, and can be added in lesser amounts to the dough of the invention as it is more effective in its isolated form. In one embodiment Aytex® P wheat starch produced by Archer Daniels Midland Company (Decatur, Ill.) may be used. Aytexe P wheat starch is exceptionally white in color, gelatinizes at low cooking temperatures, and forms cool pastes which are delicate and smooth in texture and resistant to overmixing and reheating. The white color of the wheat starch also substantially lightens the high-protein content tortilla, which is typically darker than wheat flour tortillas because of the high protein content. This imparts a more desirable appearance to the tortilla.

Wheat starch generally cooks more readily than most starches, having a gelatinization range about 10° C. lower than other starches, such as corn or waxy maize. Wheat starch furthermore is very useful in food compositions as its formation of softer, more tender pastes and gels is preferable in comparison with other more coarse starches. This results in better organoleptic properties, providing mouth feel and palatability preferences in food products as compared to other starch products. The granule size may be in a range of 20-40 microns in diameter and gelatinize at a temperature range of approximately 52° C. to 64° C.

The term “soluble fiber” as used herein refers to an indigestible water-soluble fiber, such as indigestible starch. Indigestible starch includes indigestible dextrins such as, for example, digestion resistant maltodextrin. Such indigestible starches are commercially available from Matsutani America (Decatur, Ill.) under the trade names Fibersol® and Fibersol-2®, Fibersol-2B®, and Fibersol-2H® which are very soluble in water but have digestion properties similar to fibrin. For example, Fibersol-2® is soluble at 70% w/w at 20° C. and has a molecular weight of 2000 MW. In one non-limiting process for making indigestible dextrins, such as Fibersol®, starches are hydrolyzed by acid or enzymes to shorter chain carbohydrates comprised of glucose units. While completely hydrolyzed starch will yield glucose, intermediate products include such dextrins as found in Fibersol®.

All starches are composed of mostly α-1-4 linkages between the glucose units with relatively few α-1, 2; α-1, 3; and α-1, 6 bonds. As starches can be hydrolyzed to maltodextrins and glucose syrups, these products continue to have glucose units linked by α-1, 4 bonds. Dextrins are made by hydrolyzing starches in a dry state by the addition of acid and heat. This process causes glucose obtained by hydrolysis to recombine with the larger carbohydrates to form α-1, 2, α-1, 3, and α-1, 6 bonds. Adding additional heat and/or acids give highly branched carbohydrates, or pyrrodextrins, and further treatment give dextrins such as Fibersol®. U.S. Pat. No. 5,458,892, for example, provides a non-limiting example of indigestible dextrin, and is herein incorporated by reference in its entirety.

As used herein, “net carb” is calculated by subtracting the grams of fiber and sugar alcohols from the total carbohydrates in a food sample. The term “low carbohydrate” (abbreviated as “low carb”) refers to a food having a relatively low carbohydrate content (either total or net) compared to other foods or even the same foods but made using traditional formulas. Low carbohydrate foods include, for example, a dough or bread product derived therefrom that has a reduced carbohydrate content.

As used herein, “reduced carbohydrate” refers to dough, and bread products derived therefrom, comprising an ingredient of the invention wherein the carbohydrate content of the dough or bread products derived therefrom is less than that of the same dough or bread product of the same mass but made without the addition of a composition of the invention, and thus includes embodiments where a composition of the invention has been substituted for all or part of the flour content.

As used herein, “increased protein” refers to dough, and bread products derived therefrom, comprising an ingredient of the invention wherein the protein content of the dough or bread products derived therefrom is greater than that of the same dough or bread product of the same mass but made without the addition of a composition of the invention, and thus includes embodiments where a composition of the invention has been substituted for all or part of the flour content.

As used herein, “increased fiber” refers to dough, and bread products derived therefrom, comprising an ingredient of the invention wherein the fiber content of the dough or bread products derived therefrom is greater than that of the same dough or bread product of the same mass but made without the addition of a composition of the invention, and thus includes embodiments where a composition of the invention has been substituted for all or part of the flour content.

A “chemical leavening additive” as used herein refers collectively to an acid and a base which may be used in a bread composition to provide a chemical reaction which forms a gas in order to expand the bread dough composition. The gas formed from the reaction is generally carbon dioxide, and many different acid-based combinations may be used as the reactants. Some examples include, but are not limited to, sodium aluminum phosphate, sodium acid pyrophosphate, monocalcium phosphate, ammonium bicarbonate, sodium aluminum sulfate, and yeast.

A “shortening additive” as used herein refers to an additive, usually a fat or oil, which is used in a bread dough composition to provide a crust, or slightly harder edge surface to the bread. Some examples include, but are not limited to, butter, vegetable oils, margarine, and other shortening agents well known in the art.

The term “alpha cellulose” as used herein refers to a polysaccharide consisting of anhydrous glucose units joined by an oxygen linkage to form long molecular chains that are essentially linear. Alpha cellulose has the highest degree of polymerization than beta and gamma cellulose and is a fiber powder which may be introduced into the bread dough composition.

The term “wheat flour” as used herein refers to the standard composite powder derived from the milling, grinding and sifting of a wheat grain, comprising the endosperm which is separated from the bran and germ. The wheat flour includes but is not limited to the agglomeration of starches, gluten, pentosans, lipids, fiber, vitamins, and minerals, as well as bran and other constituents which may be present, if combined with the bran and germ. In some embodiments, the wheat flour has not been treated mechanically or chemically in order to separate the starches and gluten components.

In one embodiment, the method of making the bread product provided herein comprises the utilization of wheat starch at an amount of from 35% to 45% by wt. of the dry mixture, the utilization of wheat protein isolate in amounts of from 13% to 22% by wt. of the dry mixture, and the utilization of a soluble fiber in amounts of from 5% to 9% by wt. of the dry mixture. In another embodiment, the method of preparing a bread product provided herein includes using wheat starch in an amount of from 37.5% to 42.5% by wt. of the dry mixture, using a wheat protein isolate in an amount of from 15% to 20% by wt. of the dry mixture, and using the soluble fiber in an amount of from 6% to 8% by wt. of the dry mixture.

It has also been surprisingly found that the methods included herein have produced bread products which have extended shelf-life as compared to bread products prepared from bread dough made from wheat flour. Because the ingredients included in the bread dough and bread products derived therefrom resist absorbing water during baking, the resulting bread product will have substantially increased moisture content in comparison to a bread product produced from a bread dough comprising wheat flour. Such embodiments lead to increased shelf-life of the bread product as the increased moisture content retards the staling process of the bread.

The addition of a soluble fiber, such as Fibersol-2®, has surprisingly had a significant impact on the baking process. In certain embodiments, the bread product has increased fiber content, increased protein content, reduced carbohydrate content, and combinations thereof. Unlike most soluble fibers, Fibersol-2® helps ensure the presence of adequate water for the mixing and baking and leavening stages of the bread. In addition, Fibersol-2® has been found to have an abundance of health benefits including effects on the digestive tract, blood glucose, and cholesterol levels. Fibersol-2® has been shown to increase both bowel regularity and fecal volume. It has further been found to significantly increase proportions of bifidobacteria in intestinal microflora. The increase in these probiotic levels has numerous and well documented health benefits, such as strengthening of the immune system, increasing production of white blood cells, anti-carcinogenic properties, and the like.

### EXAMPLES

The following are examples of methods and compositions of the invention, including, for example, tortillas. The examples are not meant to limit the scope of the invention, as defined by the claims.

### Example 1

A tortilla was prepared using the following specifications. First, the components were mixed together into a dough. 200 grams of Aytex® P wheat starch was mixed with 80 grams of Whetpro® 82 wheat gluten (ADM Arkady, Olathe, Kans.), 65 grams of alpha cellulose fiber, 50 grams of ADM Prolite® 100 wheat isolate (ADM, Keokuk, Iowa), 28 grams of ADM AZ Arkady flour tortilla base, 40 grams of tortilla shortening, and 35 grams of Fibersol-2® (Matsutani America, Decatur, Ill.). The ADM AZ Arkady flour tortilla base is a complete base for making flour tortillas and is commercially available (ADM Arkady, Olathe, Kans.). The base includes all necessary ingredients to make uniform flour tortillas and has been premeasured to insure proper gradations of the ingredients. Included in the base are salt, sodium bicarbonate, calcium propionate, corn starch, sodium acid pyrophosphate, fumaric acid, sodium stearoyl lactylate, guar gum, monoglycerides, yeast, soy bean oil, and L-cysteine. The dry ingredients were mixed with the shortening for three to five minutes in a mixer on low. Water was then added and the dough was mixed at slow speed, approximately for one minute, and then mixed for five minutes at high speed. The temperature of the dough during the mixing with the water was approximately 32° C. to 38° C. The dough was then formed into 57 g dough balls by hand and allowed to sit for 15 minutes. The dough balls were then pressed by a tortilla press and then cooked for 45 to 60 seconds at approximately 252° C.

### Example 2

Dough was prepared by combining the ingredients shown in Table 1. The dough was prepared according to the method as described in Example 1.

TABLE 1

| | A | B |
|---|---|---|
| Ingredients | Grams | Grams |
| Wheat starch (Aytex P ® ADM Arkady, Olathe, KS) | 200 | 200 |
| Water | 300 | 320 |
| Whetpro 82 ™ (ADM, Candiac, Canada) | 80 | 90 |
| Prolite 100 ® (ADM, Keokuk, IA) | 50 | 40 |
| AZ Tortilla Base 113-617 ™ (ADM Arkady, | 28 | 28 |
| Olathe, KS) | | |
| Tortilla shortening | 40 | 40 |
| Fibersol 2 ® (Matsutani America, Decatur, IL) | 35 | 35 |
| Wheat fiber (Vitacell WF600-30 ® JRS, | 65 | 65 |
| Rosenberg, Germany) | | |

### Example 3

Dough was prepared by combining the ingredients shown in Table 2 to yield a dry mix at 100%, water at 93%, and shortening at 13.54%. The dough was prepared according to the following procedure:
1. Cream dry ingredients and shortening 3-5 minutes on low.
2. Add water and mix dough on slow speed. Temperature of dough should be 32° C.-38° C.
3. Scaling: 57 g ball.
4. Rest time: 15 minutes.
5. Press and cook for 45-60 seconds.

Tortillas produced from this mix had 8.9 grams net carbs per 32 gram serving. The tortillas had a dietary content as shown in Table 3 and contained the ingredients: water, wheat starch, gluten, alpha cellulose fiber, gluten isolate, shortening, and maltodextrin, while the following were 2% or less: salt, baking powder, fumaric acid, calcium propionate, corn starch, sodium stearoyl lactate, mono & diglycerides, guar gum, yeast, soybean oil, and L-cysteine.

TABLE 2

| | True | |
|---|---|---|
| Ingredients | percent | Grams |
| Wheat starch (Aytex P ® ADM Arkady, Olathe, KS) | 24.15 | 200 |
| Water | 39.85 | 330 |
| ADM WHETPRO 80 Vital Wheat Gluten ® | 9.66 | 80 |
| (ADM Arkady, Olathe, KS) | | |
| Alpha cellulose fiber | 7.85 | 65 |
| Prolite 100 ® (ADM, Keokuk, IA) | 6.03 | 50 |
| AZ tortilla base 113-617 ™ (ADM Arkady, | 3.38 | 28 |
| Olathe, KS) | | |
| Tortilla shortening (Golden Chef ® ADM, | 4.83 | 40 |
| Decatur, IL) | | |
| Fibersol 2 ™ (Matsutani America, Decatur, IL) | 4.22 | 35 |
| Guar Gum | | 5 |

TABLE 3

| Calories | Calories from Fat 20 |
|---|---|
| 100 | % Daily Value* |
| Total Fat 2.2 g | 4% |
| Saturated Fat 0.5 g | 0% |
| Cholesterol 0 mg | 0% |
| Sodium 340 mg | 14% |
| Total Carbohydrate 13.5 g | 4% |
| Dietary Fiber 4.6 g | 13% |
| Sugars 0 g | |
| Protein 4.6 g | |
| Vitamin A | 0% |
| Vitamin C | 0% |
| Calcium | 4% |
| Iron | 8% |

*Percent Daily Values based on a 2,000 calorie diet. Individual daily values may vary.

### Example 4

Dough was prepared by combining the ingredients shown in Table 4. The dough was prepared according to the following method:
1. Cream dry ingredients and shortening 3-5 minutes on low.
2. Add water and mix dough on slow speed. Temperature of dough should be 32-38° C.
3. Scaling: 57 g ball.
4. Rest time: 15 minutes.

5. Press and cook for 45-60 seconds.

TABLE 4

| Ingredients | Grams |
|---|---|
| Gluten | 80 |
| Oat fiber (Vitacel ™, JRS, Posenberg, Germany) | 65 |
| Prolite 100 ® (Wheat protein isolate, ADM Arkady, | 50 |
| Olathe, KS) | |
| ADM AZ Tortilla Base ™ (ADM, Decatur, IL) | 28 |
| Shortening | 40 |
| Water | 330 |
| Wheat starch | 200 |
| Fibersol 2 (Matsutani America, Decatur, IL) | 35 |

It will be appreciated by those skilled in the art that changes could be made to the embodiments described herein without departing from the broad concept of the invention. It is understood, therefore, that this invention is not limited to the particular embodiments disclosed, but is intended to cover modifications that are within the spirit and scope of the invention as defined by the claims.

What is claimed is:

1. A method of preparing a bread product substantially free of wheat flour comprising mixing wheat starch with a wheat protein isolate, and a soluble fiber to form a dry mixture, adding water to said dry mixture, and baking to form a bread product.

2. A method of preparing the bread product of claim 1, wherein said soluble fiber is an indigestible dextrin.

3. The method of preparing the bread product of claim 1, wherein said protein isolate is wheat gluten.

4. The method of preparing the bread product of claim 1, further comprising mixing a chemical leavening additive, a shortening additive, and salt into said dry mixture.

5. The method of preparing the bread product of claim 4, further comprising mixing an alpha cellulose fiber into said dry mixture.

6. The method of preparing the bread product of claim 1, wherein said wheat starch comprises from 30% to 50% by weight of said dry mixture, said wheat protein isolate comprises from 10% to 25% by weight of said dry mixture, and said soluble fiber comprises from 4% to 10% by weight of said dry mixture.

7. The method of preparing the bread product of claim 6, wherein said wheat starch comprises from 35% to 45% by weight of said dry mixture, said wheat protein isolate comprises from 13% to 22% by weight of said dry mixture, and said soluble fiber comprises from 5% to 9% by weight of said dry mixture.

8. The method of preparing the bread product of claim 7, wherein said wheat starch comprises from 37.5% to 42.5% by weight of said dry mixture, said wheat protein isolate comprises from 15% to 20% by weight of said dry mixture, and said soluble fiber comprises from 6% to 8% by weight of said dry mixture.

9. The method of preparing the bread product of claim 1, wherein said bread product is a tortilla.

10. A bread dough comprising a dry mixture and water, said dry mixture comprising:
a wheat starch, and
a wheat protein isolate, and
a soluble fiber.

11. The bread dough of claim 10, wherein said soluble fiber comprises indigestible dextrin.

12. The bread dough of claim 10, wherein said wheat protein isolate is wheat gluten.

13. The bread dough of claim 10, further comprising a chemical leavening additive and a shortening additive.

14. The bread dough of claim 13, further comprising an alpha cellulose fiber, and a salt.

15. The bread dough of claim 10, wherein said wheat starch comprises from 30% to 50% by weight of said dry mixture, said wheat protein isolate comprises from 10% to 25% by weight of said dry mixture and said soluble fiber comprises from 4% to 10% by weight of said dry mixture.

16. The bread dough of claim 15, wherein said wheat starch comprises from 35% to 45% by weight of said dry mixture, said wheat protein isolate comprises from 13% to 22% by weight of said dry mixture and said soluble fiber comprises from 5% to 9% by weight of said dry mixture.

17. The bread dough of claim 16, wherein said wheat starch comprises from 37.5% to 42.5% by weight of said dry mixture, said wheat protein isolate comprises from 15% to 20% by weight of said dry mixture and said soluble fiber comprises from 6% to 8% by weight of said dry mixture.

18. The bread dough of claim 10, wherein said bread dough is a tortilla dough.

19. A bread product made from the method comprising mixing a wheat starch with a wheat protein isolate and a soluble fiber to form a dry mixture, adding water to said dry mixture, and baking to form said bread product.

20. The bread product of claim 19, wherein said bread product is a tortilla.
